(19) United States
(12) Patent Application Publication
(10) Pub. No.: US 2023/0332945 A1
(43) Pub. Date: Oct. 19, 2023

(54) METHOD FOR CALCULATING GLOBAL ILLUMINATION OF THREE-DIMENSIONAL SPACE, APPARATUS, DEVICE, AND STORAGE MEDIUM

(71) Applicant: Tencent Technology (Shenzhen) Company Limited, Shenzhen (CN)

(72) Inventor: Letian YU, Shenzhen (CN)

(73) Assignee: Tencent Technology (Shenzhen) Company Limited, Shenzhen (CN)

(21) Appl. No.: 18/341,011

(22) Filed: Jun. 26, 2023

Related U.S. Application Data
(63) Continuation of application No. PCT/CN2022/136272, filed on Dec. 2, 2022.

(30) Foreign Application Priority Data
Mar. 8, 2022 (CN) 202210220452.5

(51) Int. Cl. G01J 1/42

(52) U.S. Cl. CPC G01J 1/42

(57) ABSTRACT

Methods, apparatuses, and systems for calculating global illumination of a three-dimensional space are provided. The three-dimensional space includes a first and second local space. A first local description operator is obtained for the first local space. A second local description operator is obtained for the second local space. A first reflected illumination of the first local space is determined according to the first local description operator and a first incident illumination. A second reflected illumination of the second local space is determined according to the second local description operator and a second incident illumination. A global reflected illumination of the first local space is determined according to the first reflected illumination, the second reflected illumination, and the first local description operator. The first local description operator describes space information of the first local space. The second local description operator describes space information of the second local space.

### RELATED APPLICATION

The present application is a continuation of PCT application PCT/CN2022/136272 filed Dec. 2, 2022, which claims priority to Chinese Patent Application No. 202210220452.5 filed on Mar. 8, 2022 and entitled “Method for calculating global illumination of three-dimensional space, apparatus, device, and storage medium.” All are incorporated by reference in their entirety.

### FIELD OF THE TECHNOLOGY

The present subject matter relates to the technical field of rendering, in particular to a method for calculating global illumination of a three-dimensional space, apparatus, device, and a storage medium.

### BACKGROUND OF THE DISCLOSURE

With development of a computer technology, complexity of illumination calculation in a three-dimensional space is increasing, which puts forward high requirements for computing power of a computer device.

In related arts, when illumination calculation is performed on a three-dimensional space, reflected illumination of each position in the three-dimensional space usually needs to be calculated one by one, and the reflected illumination of all positions constitutes a reflected illumination condition of the three-dimensional space; for any position in the three-dimensional space, incident illumination at the position includes incident illumination from a light source and reflected illumination from other positions.

However, with continuous expansion of a three-dimensional space, more and more positions need to perform illumination calculation, and calculation of reflected illumination in the three-dimensional space becomes more and more complex, so how to reduce complexity of calculation is an urgent problem to be solved.

### BRIEF SUMMARY

The present subject matter provides a method for calculating global illumination of a three-dimensional space, apparatus, device, and a storage medium. The technical solutions are as follows:

According to one aspect, the present subject matter provides a method for calculating global illumination of a three-dimensional space. The three-dimensional space includes a first local space and a second local space. The method is executed by a terminal, and the method includes:
obtaining a first local description operator of the first local space, and obtaining a second local description operator of the second local space;
determining first reflected illumination of the first local space according to the first local description operator and first incident illumination of the first local space, and determining second reflected illumination of the second local space according to the second local description operator and second incident illumination of the second local space;
determining global reflected illumination of the first local space according to the first reflected illumination, the second reflected illumination, and the first local description operator;
where the first local description operator describes space information of the first local space, and the second local description operator describes space information of the second local space.

According to another aspect, the present subject matter provides an apparatus for calculating global illumination of a three-dimensional space. The three-dimensional space includes a first local space and a second local space. The apparatus includes:
an obtaining module, configured to obtain a first local description operator of the first local space and a second local description operator of the second local space;
a processing module, configured to determine first reflected illumination of the first local space according to the first local description operator and first incident illumination of the first local space, and determine second reflected illumination of the second local space according to the second local description operator and second incident illumination of the second local space;
the processing module, further configured to determine global reflected illumination of the first local space according to the first reflected illumination, the second reflected illumination, and the first local description operator;
where the first local description operator describes space information of the first local space, and the second local description operator describes space information of the second local space.

In an optional design of the present subject matter, the processing module is further configured to:
determine influencing reflected illumination of the first local space according to the second reflected illumination and the first local description operator, the influencing reflected illumination describes an influence of second reflected illumination of the second local space on the first local space;
determine the global reflected illumination of the first local space according to the first reflected illumination and the influencing reflected illumination.

In an optional design of the present subject matter, the processing module is further configured to: determine influencing reflected illumination of the first local space according to the second reflected illumination, the first local description operator, and first visibility information, the first visibility information describes whether an occlusion exists in a different illumination direction in the first local space.

In an optional design of the present subject matter, the processing module is further configured to:
determine sphere harmonics of the influencing reflected illumination of the first local space according to a product of sphere harmonics of the second reflected illumination, the first local description operator, and the first visibility information.

In an optional design of the present subject matter, the processing module is further configured to:
determine the first reflected illumination according to the first local description operator, the first incident illumination, and first visibility information, the first visibility information describes whether an occlusion exists in a different illumination direction in a first local space;
determine the second reflected illumination according to the second local description operator, the second incident illumination, and second visibility information, the second visibility information describes whether an occlusion exists in a different illumination direction in a second local space.

In an optional design of the present subject matter, the processing module is further configured to:
determine sphere harmonics of the first reflected illumination according to a product of the first local description operator, sphere harmonics of the first incident illumination, and the first visibility information;
determine sphere harmonics of the second reflected illumination according to a product of the second local description operator, sphere harmonics of the second incident illumination, and the second visibility information.

In an optional design of the present subject matter, the apparatus further includes:
a dividing module, configured to divide to obtain at least two local spaces in the three-dimensional space;
a determining module, configured to determine the first local space in the at least two local spaces;
the determining module, further configured to determine the second local space in multiple remaining local spaces according to position information of the first local space, the remaining local spaces is local spaces other than the first local space in the at least two local spaces.

In an optional design of the present subject matter, the determining module is further configured to:
calculate spacing distances between the first local space and the remaining local spaces according to position information of the first local space;
distances;
sort the remaining local spaces from small to large according to the spacing
determine first the remaining local spaces in the sorting as the second local spaces, a is a positive integer.

In an optional design of the present subject matter, the dividing module is further configured to: divide to obtain the at least two local spaces in the three-dimensional space according to a distribution condition of objects in the three-dimensional space.

In an optional design of the present subject matter, the dividing module is further configured to:
determine a space with a first object as a first subspace according to a distribution condition of objects in the three-dimensional space;
divide to obtain the at least two local spaces in the first subspace according to the at least one of a material and a structure of the first object and position information in the first subspace.

In an optional design of the present subject matter, the determining module is further configured to: construct the first local description operator of the first local space according to a first object in the first local space, and construct the second local description operator of the second local space according to a second object in the second local space.

In an optional design of the present subject matter, the determining module is further configured to:
construct the first local description operator of the first local space according to at least one of a material and a structure of the first object and position information of the first local space, and construct the second local description operator of the second local space according to at least one of a material and a structure of the second object and position information of the second local space.

In an optional design of the present subject matter, the apparatus further includes:
a combining module, configured to combine the global reflected illumination of the multiple first local spaces to determine global reflected illumination of the three-dimensional space;
a sampling module, configured to sample global reflected illumination of the three-dimensional space to obtain a first image, the first image is an image for observing the three-dimensional space at a first view angle.

According to another aspect, the present subject matter provides a computer device. The computer device includes a processor and a memory, and the memory stores at least one instruction, and the at least one instruction is loaded and executed by the processor to implement a method for calculating global illumination of the three-dimensional space as described in the above aspect.

According to another aspect, the present subject matter provides a non-transitory computer-readable storage medium. The readable storage medium stores at least one instruction, and the at least one instruction is loaded and executed by a processor to implement the method for calculating global illumination of the three-dimensional space as described in the above aspect.

According to another aspect, the present subject matter provides a computer program product. The computer program product includes a computer instruction, and the computer instruction is stored in a non-transitory computer-readable storage medium, and a processor reads from the computer-readable storage medium and executes the computer instruction to implement the method for calculating global illumination of the three-dimensional space as described in the above aspect.

The technical solutions provided in the present subject matter have at least the following beneficial effects:
by determining first reflected illumination of first local space, a process of calculating reflected illumination of each position in the three-dimensional space one by one is simplified, and a connection is established between the reflected illumination of the first local space and the first local space; by a first local description operator, first reflected illumination and second reflected illumination, global reflected illumination of first local space is determined, and complexity of calculating global illumination is simplified. A local space includes multiple positions, and a global reflected illumination condition of the three-dimensional space can be calculated from granularity of the local space without calculating global reflected illumination of each position in the three-dimensional space. In other words, in a case that global reflected illumination of one position needs to be calculated, a problem of a large calculation amount caused by the fact that reflected illumination of all positions in the three-dimensional space needs to be used when global reflected illumination of one position is calculated is avoided. Therefore, the present subject matter expands a calculation dimension of calculating global reflected illumination by reflected illumination of the second local space; a calculation amount of global illumination calculation is effectively reduced.

### BRIEF DESCRIPTION OF THE DRAWINGS

FIG. 1 is a schematic diagram of a computer system provided by an example of the present subject matter.

FIG. 2 is a flowchart of a method for calculating global illumination of a three-dimensional space provided by an example of the present subject matter.

FIG. 3 is a schematic diagram of a three-dimensional space scene provided by an example of the present subject matter.

FIG. 4 is a schematic diagram of a three-dimensional space scene provided by an example of the present subject matter.

FIG. 5 is a flowchart of a method for calculating global illumination of a three-dimensional space provided by an example of the present subject matter.

FIG. 6 is a flowchart of a method for calculating global illumination of a three-dimensional space provided by an example of the present subject matter.

FIG. 7 is a schematic diagram of a local space provided by an example of the present subject matter.

FIG. 8 is a flowchart of a method for dividing a local space in a three-dimensional space provided by an example of the present subject matter.

FIG. 9 is a flowchart of a method for calculating global illumination of a three-dimensional space provided by an example of the present subject matter.

FIG. 10 is a schematic diagram of a local space provided by an example of the present subject matter.

FIG. 11 is a flowchart of a method for calculating global illumination of a three-dimensional space provided by an example of the present subject matter.

FIG. 12 is a flowchart of a method for determining global reflected illumination provided by an example of the present subject matter.

FIG. 13 is a flowchart of a method for calculating global illumination of a three-dimensional space provided by an example of the present subject matter.

FIG. 14 is a flowchart of a method for calculating global illumination of a three-dimensional space provided by an example of the present subject matter.

FIG. 15 is a structural block diagram of an apparatus for calculating global illumination of a three-dimensional space provided by an example of the present subject matter.

FIG. 16 is a structural block diagram of a server provided by an example of the present subject matter.

### DETAILED DESCRIPTION

User information (including but not limited to user device information, user personal information, etc.) and data (including but not limited to data for analysis, stored data, displayed data, etc.) involved in the present subject matter are authorized by a user or sufficiently authorized by various parties, and collection, use, and processing of related data require compliance with related laws and regulations and standards in related countries and areas. For example, a first local description operator of a first local space, a second local description operator of a second local space, global reflected illumination of the first local space and parameter information involved in the present subject matter are all obtained with full authorization.

FIG. 1 is a schematic diagram of a computer system provided by an example of the present subject matter. The computer system may be implemented as a system architecture for a method for calculating global illumination of a three-dimensional space. The computer system may include: a terminal 100 and a server 200. The terminal 100 may be an electronic device such as a mobile phone, a tablet computer, a vehicle-mounted terminal (a vehicle machine), a wearable device, a personal computer (PC) and an unattended reservation terminal. The terminal 100 may be installed with a client for running a target application program, and the target application program may be a global illumination calculation application program of a three-dimensional space or another application program providing a global illumination calculation function of a three-dimensional space, which is not limited in the present subject matter. Besides, in the present subject matter, a form of the target application program is not limited, and includes, but is not limited to, an App (Application) installed in the terminal 100, an applet, and the like, and may further be a web page. The server 200 may be an independent physical server, or a server cluster composed of multiple physical servers or a distributed system, or a cloud server providing a cloud computing service. The server 200 may be a background server of the target application program, and is configured to provide a background service for the client with the target application program.

According to a method for calculating global illumination of a three-dimensional space provided by an example of the present subject matter, an execution subject of each step may be a computer device, and the computer device refers to an electronic device capable of calculating, processing and storing data. Taking a solution implementation environment as shown in FIG. 1 as an example, a method for calculating global illumination of a three-dimensional space may be executed by a terminal 100 (for example, the method for calculating global illumination of a three-dimensional space may be executed by a client running a target application program installed in the terminal 100), or may also be executed by a server 200, or executed by the terminal 100 and the server 200 in cooperation with each other, which is not limited herein.

Besides, technical solutions of the present subject matter can be combined with a blockchain technology. For example, according to a method for calculating global illumination of a three-dimensional space provided by the present subject matter, some data involved therein (data such as a first local description operator of a first local space, a second local description operator of a second local space, and global reflected illumination of the first local space) may be stored on a blockchain. A terminal 100 may communicate with a server 200 by using a wireless or wired network.

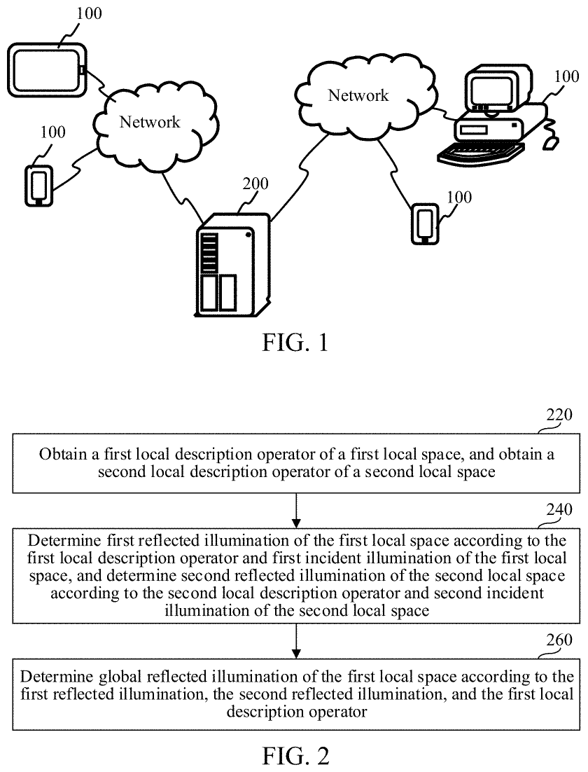

FIG. 2 is a flowchart of a method for calculating global illumination of a three-dimensional space provided by an example of the present subject matter. The method may be executed by a computer device. The method includes:

Step 220: Obtain a first local description operator of a first local space, and obtain a second local description operator of a second local space.

A three-dimensional space refers to a space for accommodating a three-dimensional virtual environment. The three-dimensional virtual environment refers to a virtual environment displayed (or provided) in a case that an application program runs on a terminal. The three-dimensional virtual environment can be a simulation environment of a real world, or a semi-simulation and semi-fictional environment, or a purely fictional environment. Taking a three-dimensional virtual environment as a virtual environment under a game scene as an example, the three-dimensional virtual environment can provide a battle environment for a virtual object.

A three-dimensional space includes a first local space and a second local space. As an example, a union of a first local space and a second local space is generally smaller than a three-dimensional space, that is, the union of the first local space and the second local space is generally a part of the three-dimensional space; shapes of the first local space and the second local space are generally sphere, but it is not excluded that they are cuboid, cylinder, cone, or other solid shapes. The first local space refers to any local space obtained by dividing in a three-dimensional space; the second local space refers to an associated space of the first local space, and the second local space is a local space where reflected illumination may irradiate the first local space in the three-dimensional space.

As an example, the number of first local spaces and/or second local spaces included in a three-dimensional space may be one or more; in a case that multiple first local spaces are included in the three-dimensional space, shape features of different first local spaces may be the same or different; in a possible implementation, overlapping areas may exist between different first local spaces; shape features and a position relationship of a first local space and/or a second local space are not subject to any restrictive provisions in the present subject matter.

A first local description operator describes space information of a first local space, and a second local description operator describes space information of a second local space; as an example, a first description operator may directly describe a first local space by describing at least one of a shape feature, a position feature, or other attributes of the first local space; the first local space may further be indirectly described by describing first objects in the first local space, such as at least one of shapes, sizes, colors of the first objects, positions of the first objects in the first local space, or another attribute, the first objects is all or part of objects in the first local space; it is to be understood that the first local description operator may simultaneously describe the first local space and the first objects in the first local space. Similarly, a second local description operator can further describe a second local space directly or indirectly.

In an example, a shape feature of a first local space refers to an outline of the first local space. In an example, a first local description operator of a first local space is constructed according to at least one of a material and a structure of a first object and position information of the first local space;
for example, a material of the first object includes but is not limited to, at least one of the following: a color of the first object and a reflective attribute of the first object;
a structure of the first object includes, but is not limited to, at least one of the following: a shape of the first object and a size of the first object;
in a further example, a first local description operator describes at least one of following parameters:
   position information of a first local space, such as: a position of the first local space in a three-dimensional space;
   a structure of a first object in the first local space, such as: a position of the first object in the first local space and a shape of the first object;
   a material of the first object in the first local space, such as: a color of the first object and a reflective attribute of the first object;
that is, the first local space and the first object in the first local space are simultaneously described.

As an example, a representation form of a first local description operator and/or a second local description operator includes, but is not limited to, at least one of a matrix, a vector, and a feature value.

As an example, a basis of obtaining a local space by dividing in a three-dimensional space includes, but is not limited to, at least one of the following: an object distribution condition in the three-dimensional space, complexity of an appearance of an object in the three-dimensional space, a color attribute of an object in the three-dimensional space and a relative position relationship between different objects in the three-dimensional space; the present subject matter does not make any restrictive provisions on the basis of dividing the local space.

Step 240: Determine first reflected illumination of the first local space according to the first local description operator and first incident illumination of the first local space, and determine second reflected illumination of the second local space according to the second local description operator and second incident illumination of the second local space;
as an example, first reflected illumination of a first local space describes a reflection condition after first incident illumination is incident to the first local space, that is, reflection conditions of all objects in the first local space to the first incident illumination; similarly, second reflected illumination of a second local space describes a reflection condition after second incident illumination is incident to the second local space;
as an example, first incident illumination of a first local space describes an illumination condition incident to the first local space; similarly, second incident illumination of a second local space describes an illumination condition incident to the second local space.

A representation form of incident illumination or reflected illumination in the first local space and the second local space includes, but is not limited to a matrix, a vector, and a function.

Step 260: Determine global reflected illumination of the first local space according to the first reflected illumination, the second reflected illumination, and the first local description operator.

The second local space is an associated space of the first local space, and the second reflected illumination of the second local space influences the first local space; as an example, a second local space is a local space where reflected illumination may irradiate a first local space in the three-dimensional space.

As an example, global reflected illumination of a first local space describes reflection conditions of all objects in the first local space to all illumination incident to the first local space in a three-dimensional space; as an example, all illumination incident to a first local space includes first incident illumination of the first local space and second reflected illumination of a second local space. That is, global reflected illumination illustrates an influence of second reflected illumination on first reflected illumination, and describes illumination conditions of all objects in the first local space in the three-dimensional space.

A second local space and a first local space may be adjacent or not adjacent, and an associated area of the second local space and the first local space does not limit an adjacency relationship between the two local spaces.

To sum up, according to the method provided by the example, by determining the first reflected illumination of the first local space, a process of calculating reflected illumination of illumination space points one by one is simplified and a connection is established between the reflected illumination of the first local space and the first local space; by the first local description operator, the first reflected illumination and the second reflected illumination, the global reflected illumination of the first local space is determined, complexity of calculating global illumination is simplified, a problem of a large calculation amount caused by the fact that reflected illumination of all positions in a three-dimensional space needs to be used when global reflected illumination of one position is calculated is avoided, and a calculation dimension of calculating the global reflected illumination by the reflected illumination of the second local space is expanded; a calculation amount of global illumination calculation is effectively reduced.

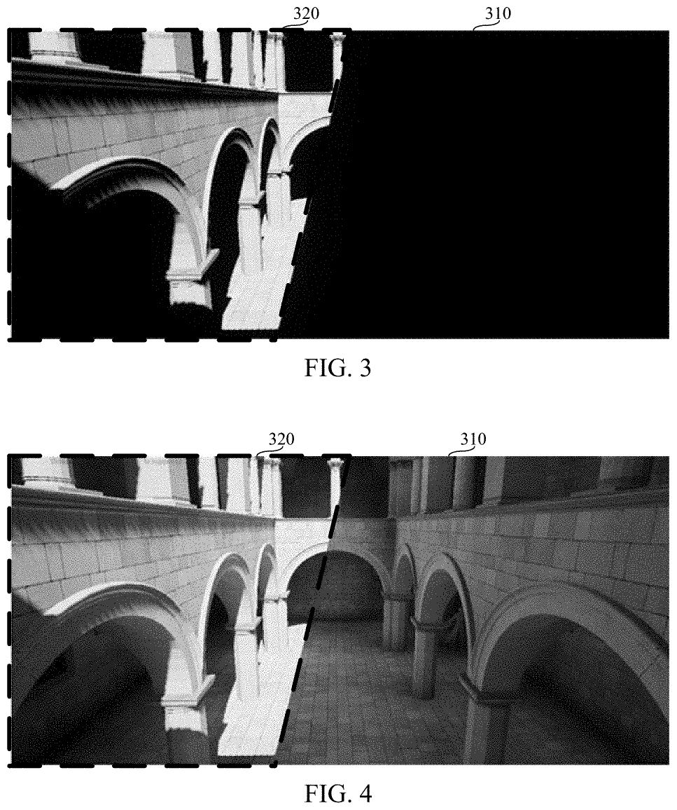

In a schematic diagram of a three-dimensional space scene in FIG. 3, a three-dimensional space includes a first local space 310 and a second local space 320; the first local space 310 is located on a right side in the schematic diagram of the three-dimensional space scene, and the first local space 310 includes a first wall; the second local space 320 is located on a left side in the schematic diagram of the three-dimensional space scene, and the second local space 320 includes a second wall. Division of the first local space and the second local space in FIG. 3 is only an exemplary description, and in optional examples of the present subject matter, more local spaces may be obtained by dividing according to other division bases.

Due to a height of the first wall in the first local space 310 on the right side of the three-dimensional space, first incident light is blocked from entering the first local space 310; first reflected illumination is not generated in the first local space 310, that is, the first local space 310 is not provided with the first reflected illumination, and is dark.

Second incident illumination is incident to the second local space 320, illuminating the second wall in the second local space 320, and the second wall reflects the second incident illumination to generate second reflected illumination.

The second reflected illumination of the second local space 320 influences the first local space 310, that is, the second reflected illumination irradiates the first local space 310 and illuminates the first wall in the first local space 310; in a schematic diagram of a three-dimensional space scene in FIG. 4, a first wall in a first local space 310 is illuminated.

Next, a local description operator will be introduced by a following example:

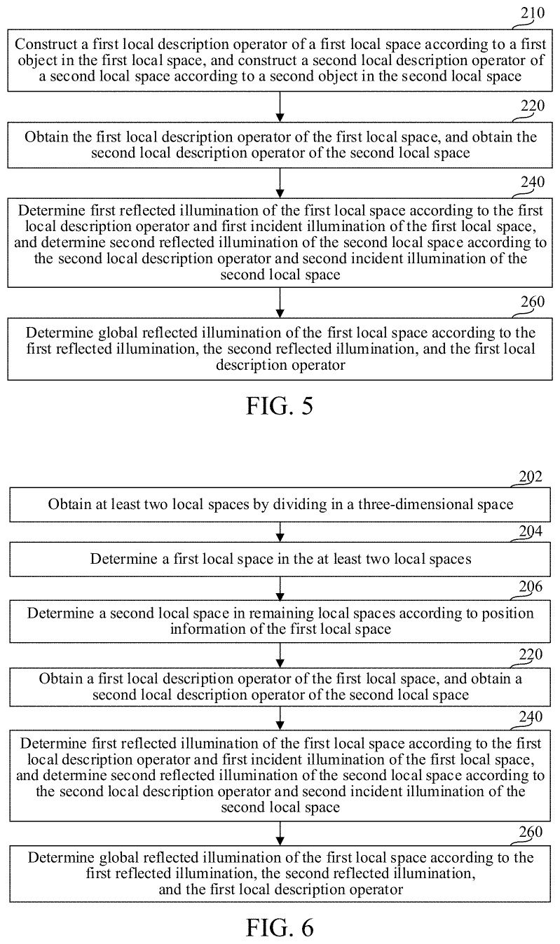

FIG. 5 is a flowchart of a method for calculating global illumination of a three-dimensional space provided by an example of the present subject matter. The method may be executed by a computer device. In an optional design, based on the example in FIG. 2, before step 220, the following steps are further included:

Step 210: Construct a first local description operator of a first local space according to a first object in the first local space, and construct a second local description operator of a second local space according to a second object in the second local space.

In this example, the first local space is indirectly described by describing the first object in the first local space;
in an optional design of this example, step 210 may be implemented by:
constructing a first local description operator of a first local space according to at least one of a material and a structure of a first object and position information of the first local space, and constructing a second local description operator of a second local space according to at least one of a material and a structure of a second object and position information of the second local space;
as an example, a material of a first object includes, but is not limited to, at least one of the following:
   a color of the first object; as an example, a color of the first object is described by an RGB color system using three color channels of red, green, and blue;
   a reflective attribute of the first object; as an example, a reflection condition of the first object to first incident light, such as, reflectivity or a refractive index of the first object;
as an example, a structure of a first object includes, but is not limited to, at least one of the following:
   a shape of the first object; as an example, a shape of the first object describes a geometric shape of the object; for example, the first object may be described by at least one of a cuboid, a cylinder, or other solid geometric shapes, or a solid geometric shape obtained by intersecting or splicing multiple solid geometric shapes;
   a size of the first object; as an example, a size of the first object describes at least one of an edge length, a generatrix length, a volume, or another parameter of the first object;
as an example, position information of a first object in a first local space describes a position of the first object in the first local space.

As an example, a local description operator corresponding to a local space has at least one of the following features: the local description operator is only related to information of the local space; the local description operator implies an infinite number of light reflections in the local space; a matrix value of the local description operator is not 0 only close to a surface of an object in the local space.

In a specific example, a first local description operator of a first local space is constructed according to a product of a color of a first object and position information of the first local space; and a second local description operator of a second local space is constructed according to a product of a color of a second object and position information of the second local space.

As an example, a first local description operator is expressed as:

$${SHL}_{i} \cdot LocalRef = {\sum }_{i = 1}^{n} \frac{4 π}{n} ( DFT ( α ) \cdot {SHL}_{i} \cdot {N}_{i} ) \cdot {N}_{Oi} Basis ( α ) \frac{{C}_{diff}}{π} ;$$

Lᵢ where represents incident light, LocalRef represents the first local description operator, SH represents sphere harmonics, DFT represents discrete Fourier transform, a represents a direction vector in a direction of incident light, Nᵢ represents a surface normal of an i space point, the first local space includes n space points, a space point is a point corresponding to an arbitrary position in the first local space, N_{Oi} represents a direction vector pointing from the first local space to the i space point, and Basis represents an orthogonal basis operation.

A person skilled in the art may understand that a constructing process of a second local description operator is similar to that of a first local description operator.

To sum up, according to the method provided by the example, by constructing a first local description operator of a first local space and constructing a second local description operator of a second local space, a foundation is laid for reducing calculation complexity of global illumination calculation; by the first local description operator, first reflected illumination and second reflected illumination, global reflected illumination of the first local space is determined, complexity of calculating global illumination is simplified, and a calculation dimension of calculating the global reflected illumination by reflected illumination of the second local space is expanded; a calculation amount of global illumination calculation is effectively reduced.

Next, a local space will be introduced by a following example:

FIG. 6 is a flowchart of a method for calculating global illumination of a three-dimensional space provided by an example of the present subject matter. The method may be executed by a computer device. In an optional design, based on the example in FIG. 2, the following steps are further included:

Step 202: Obtain at least two local spaces by dividing in a three-dimensional space.

As an example, a local space is a part of a three-dimensional space, and in an optional implementation, a local space includes at least one space point in the three-dimensional space, and any space point in the three-dimensional space exists in the local space to which it belongs. As an example, local spaces in a three-dimensional space usually do not have overlapping parts, but a possibility that two or more local spaces have overlapping parts is not excluded.

In an optional implementation, a basis of dividing at least two local spaces in a three-dimensional space includes a distribution condition of objects in the three-dimensional space; that is, at least two local spaces are obtained by dividing in the three-dimensional space according to the distribution condition of the objects in the three-dimensional space.

A person skilled in the art may understand that the above basis of dividing at least two local spaces in a three-dimensional space is only an exemplary description; at least two local spaces may be further randomly divided in the three-dimensional space.

As an example, at least two local spaces are obtained by dividing in a three-dimensional space according to a distribution density of objects in the three-dimensional space; for example, a large number of local spaces are divided in an area where objects are densely distributed, and a small number of local spaces are divided in an area where objects are sparsely distributed.

As an example, at least two local spaces are obtained by dividing in a three-dimensional space according to distribution positions of objects in the three-dimensional space; for example, a large number of local spaces are obtained by dividing in an area where objects are distributed, and a small number of local spaces are obtained by dividing in an area where no objects are distributed.

Further, in an optional implementation, following substeps may be implemented:
determining a space with a first object as a first subspace according to a distribution condition of objects in a three-dimensional space;
obtaining at least two local spaces by dividing in the first subspace according to at least one of a material and a structure of a first object and position information in the first subspace.

As an example, a three-dimensional space at least includes a first object, and a distribution area of the first object in the three-dimensional space is determined as a first subspace; further, at least two local spaces are obtained by dividing in the first subspace according to the structure of the first object; for example, in an example, a three-dimensional space includes a first wall, and a first subspace is determined according to a distribution condition of the first wall, and the first subspace includes the first wall; the first wall includes a flat wall surface and a stepped frame, complexity of the first wall at a wall surface part is low, the wall surface part is divided into a small number of local spaces, complexity of the stepped structure at a frame part is high, and the frame part is divided into a large number of local spaces.

Step 204: Determine a first local space in the at least two local spaces.

As an example, a basis of determining a first local space may be randomly determined, or may be determined according to at least one of a shape feature, a position feature, or another attribute of a local space, or may be determined according to at least one of a shape, a size, a color, a position of a first object in the first local space, or another attribute. This example does not make any restrictive provisions on the basis of determining the first local space. As an example, first local spaces determined in at least two local spaces may be one or more. In an optional implementation, one first local space exists, and global reflected illumination of the first local space is obtained according to a method for calculating global illumination of a three-dimensional space shown in the present subject matter; a person skilled in the art may understand that the at least two local spaces in this example are determined as the first local spaces one by one; corresponding global illumination is calculated in sequence.

Step 206: Determine a second local space in multiple remaining local spaces according to position information of the first local space.

The remaining local spaces are local spaces other than the first local space of the at least two local spaces. As an example, the second local spaces are usually partial spaces of the remaining local spaces, but it is not excluded that the second local spaces are all of the remaining local spaces.

As an example, in an optional implementation of this example, a second local space may be determined by a spacing distance with a first local space; a person skilled in the art may understand that a second local space may further be determined by at least one of an attribute of a remaining local space, an attribute of an object in a remaining local space, an attribute of a first local space, and an attribute of a first object in the first local space; this example does not make any restrictive provisions on a manner of determining the second local space.

In an optional implementation of this example, step 206 may be implemented as the following substeps:
calculating spacing distances between the first local space and the multiple remaining local spaces, respectively, according to the position information of the first local space;
sorting the multiple remaining local spaces from small to large according to the spacing distances;
determining first a remaining local spaces in the sorting as second local spaces, a is a positive integer.

As an example, a spacing distance between a first local space and a remaining local space may be a distance between a center point of the first local space and a center point of the remaining local space, or may be a minimum distance between any space point in the first local space and any space point in the remaining local space; a person skilled in the art may understand that a distance between a first local space and a remaining local space may be expressed in more manners, and the present subject matter does not make any restrictive provisions on this.

As an example, a is a pre-configured positive integer, and a determination manner of a is similar to a determination manner of a second local space in the above, and there are no restrictive provisions on the determination manner of a.

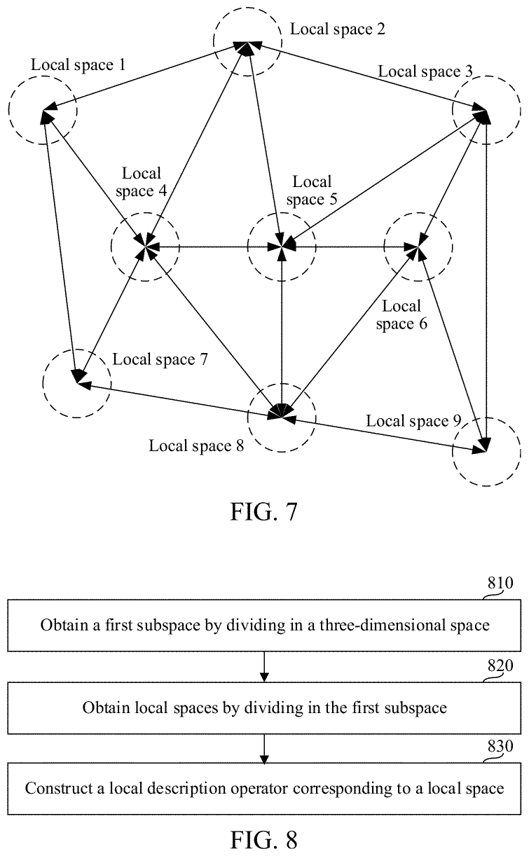

FIG. 7 is a schematic diagram of a local space provided by an example of the present subject matter; at least 9 local spaces exist in a three-dimensional space: a local space 1, local spaces 2 to 9; as an example, in a case that a local space 5 is determined as a first local space, spacing distances between the first local space and remaining local spaces are calculated according to position information of the first local space; the remaining local spaces include local spaces 1 to 4 and local spaces 6 to 9; the remaining local spaces are sorted from small to large according to the spacing distances; first five remaining local spaces in the sorting are determined as second local spaces, that is, local spaces 2, 3, 4, 6, and 8 are determined as the second local spaces. A person skilled in the art may understand that a schematic diagram of a local space outputted by FIG. 7 illustrates, as an example, an implementation manner of determining a second local space in remaining local spaces in a case that a different local space is determined as a first local space; of course, a different second local space may be determined in a different manner of determining a second local space.

This example may be combined with the example illustrated in FIG. 5 to obtain a new example; as an example, in the new example obtained by combination, an execution order of steps is step 202, step 204, step 206, and step 210.

A person skilled in the art may understand that in an optional implementation of this example, after step 202 is executed, that is, after at least two local spaces are obtained by dividing, a local description operator of a local space may be constructed respectively, and it is not necessary to construct a local description operator after a first local space and a second local space are determined. An optional implementation of each step in this example may be implemented independently in a different example, or may be combined to be implemented in the same example.

To sum up, according to the method provided by the example, by obtaining local spaces by dividing in a three-dimensional space and determining a first local space and a second local space, segmenting the three-dimensional space and laying a foundation for constructing a corresponding local space description operator; by the first local description operator, first reflected illumination and second reflected illumination, global reflected illumination of the first local space is determined, complexity of calculating global illumination is simplified, and a calculation dimension of calculating the global reflected illumination by reflected illumination of the second local space is expanded; a calculation amount of global illumination calculation is effectively reduced.

Moreover, a second local space is determined from multiple remaining local spaces by respectively calculating spacing distances between a first local space and the remaining local spaces, so that a local space (that is, the second local space) where reflected illumination may irradiate the first local space is obtained.

FIG. 8 is a flowchart of a method for dividing a local space in a three-dimensional space provided by an example of the present subject matter. The method may be executed by a computer device. The method includes:

Step 810: Obtain a first subspace by dividing in a three-dimensional space.

As an example, a three-dimensional space at least includes a first object, and a distribution area of the first object in the three-dimensional space is determined as a first subspace; that is, the first subspace is determined according to coordinates of the first object in the three-dimensional space.

In a possible implementation, in a process of arranging an object in a three-dimensional space, a first subspace may be determined first, and then a first object is placed in the first subspace in the three-dimensional space.

Step 820: Obtain local spaces by dividing in the first subspace.

As an example, local spaces are divided in the first subspace according to a structure of a first object, the number of the local spaces is a positive integer not less than 2;
for example, in an example, a three-dimensional space includes a first wall, and a first subspace is determined according to a distribution condition of the first wall, and the first subspace includes the first wall; the first wall includes a flat wall surface and a stepped frame, complexity of the first wall at a wall surface part is low, the wall surface part is divided into a small number of local spaces, complexity of the stepped structure at a frame part is high, and the frame part is divided into a large number of local spaces.

Step 830: Construct a local description operator corresponding to a local space.

As an example, a first local description operator of a first local space is constructed according to at least one of a material and a structure of a first object and position information in the first local space.

To sum up, according to the method provided by the example, a three-dimensional space is segmented by dividing local spaces in the three-dimensional space and determining a first local space and a second local space, and a foundation is laid for reducing complexity of global illumination calculation by constructing a first local description operator of the first local space and constructing a second local description operator of the second local space; by the first local description operator, first reflected illumination and second reflected illumination, global reflected illumination of the first local space is determined, complexity of calculating global illumination is simplified, and a calculation dimension of calculating the global reflected illumination by reflected illumination of the second local space is expanded; a calculation amount of global illumination calculation is effectively reduced.

Next, a process of determining first reflected illumination of a first local space and determining second reflected illumination of a second local space is introduced:

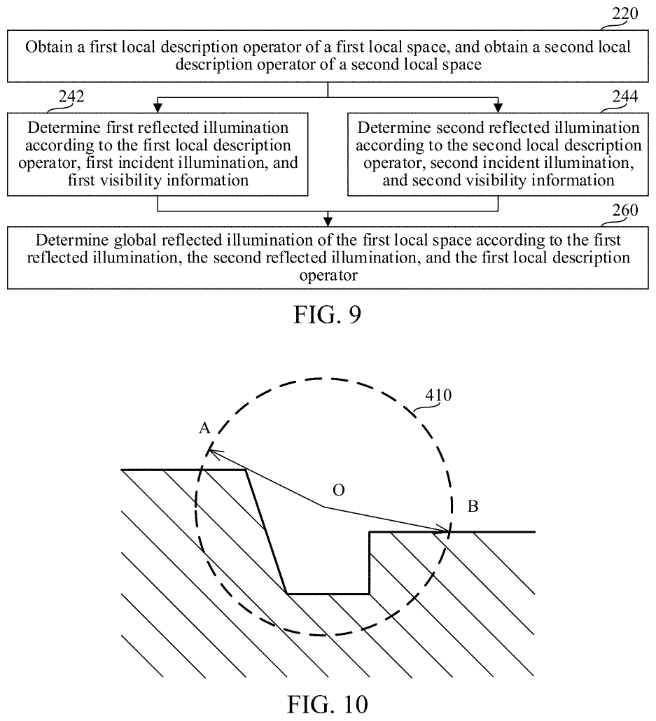

FIG. 9 is a flowchart of a method for calculating global illumination of a three-dimensional space provided by an example of the present subject matter. The method may be executed by a computer device. In an optional design, in the example in FIG. 2, step 240 includes:

Step 242: Determine first reflected illumination according to a first local description operator, first incident illumination, and first visibility information.

As an example, according to a first local description operator, first incident illumination and first visibility information, a condition that the first incident illumination is incident to a first local space is described, and a reflection condition of an object in the first local space to the first incident illumination is determined.

A representation form of incident illumination and reflected illumination of a first local space and a second local space includes, but is not limited to a matrix, a vector, and a function; as an example, both first incident illumination and first reflected illumination may be represented by Sphere Harmonics (SH); for example, in a case that first incident illumination is a second-order function, first incident illumination is represented by a four-component vector; in a case that first incident illumination is a third-order function, first incident illumination is represented by a nine-component vector;
the first visibility information describes whether an occlusion exists in a different illumination direction in a first local space; as an example, a different illumination direction is a respective direction in a first local space; the first visibility information is expressed as a binary function; as an example, in a case that no occlusion exists in a first direction in a local space, a function value corresponding to first visibility information in the first direction is 1; otherwise, in a case that an occlusion exists in a second direction in a local space, a function value corresponding to first visibility information in the second direction is 0; a person skilled in the art may understand that first visibility information may be represented by another value in a form of a binary function; first visibility information may be represented by at least one of another function, a matrix, and a vector.

In an optional implementation, sphere harmonics of first reflected illumination is determined according to a product of a first local description operator, sphere harmonics of first incident illumination, and first visibility information;
as an example, first reflected illumination is determined as:

SHLₒ=SHLᵢ·LocalRef·the first visibility information;

Lₒ where represents first reflected illumination, Lᵢ represents first incident illumination, SH represents sphere harmonics, and LocalRef represents a first local description operator;

further, according to construction of a first local description operator, the above formula may be expressed as:

$${SHL}_{o} = \frac{{\sum }_{x = 1}^{n} ( DFT ( {α}_{x} ) \cdot {SHL}_{ix} ) \frac{{C}_{diff}}{π} Basis ( {α}_{x} )}{n} 4 π ;$$

Lₒ where represents first reflected illumination, SH represents sphere harmonics, DFT represents discrete Fourier transform, αₓ represents a direction vector in an x direction, Lᵢₓ represents a triple product of a component of first incident illumination in the x direction and first visibility information, C_{diff} represents a color of a first object in a first local space, Basis represents an orthogonal basis operation, and n represents the number of the above direction vectors; as an example, n is infinite.

FIG. 10 is a schematic diagram of a local space provided by an example of the present subject matter. A three-dimensional space includes a first local space 410, the first local space 410 is a sphere with a radius of 1 m, the first local space 410 includes a ground with a groove, no occlusion exists in any direction on a minor arc AOB between a first direction OA and a second direction OB starting from a sphere center of the first local space, an occlusion exists in any direction on a dominant arc AOB between the first direction OA and the second direction OB, and first visibility information describes the above conditions of whether an occlusion exists.

Step 244: Determine second reflected illumination according to a second local description operator, second incident illumination, and second visibility information.

The second visibility information describes whether an occlusion exists in a different illumination direction in a second local space.

In an optional implementation, sphere harmonics of second reflected illumination is determined according to a product of a second local description operator, sphere harmonics of second incident illumination, and second visibility information;
as an example, second reflected illumination is determined as:

SHLₒ′=SHLᵢ′·LocalRef′·the second visibility information;

Lₒ′ where represents second reflected illumination, Lᵢ′ represents second incident illumination, SH represents sphere harmonics, and LocalRef′ represents a second local description operator.

To sum up, according to the method provided by the example, first reflected illumination is determined according to a first local description operator, first incident illumination and first visibility information by determining first reflected illumination in a first local space, a process of calculating reflected illumination of positions in a three-dimensional space one by one is simplified, complexity of calculating global illumination is simplified, a calculation dimension of calculating global reflected illumination by reflected illumination of a second local space is expanded; a foundation is laid for effectively reducing a calculation amount of global illumination.

Next, a process of determining global reflected illumination of a first local space introduced:

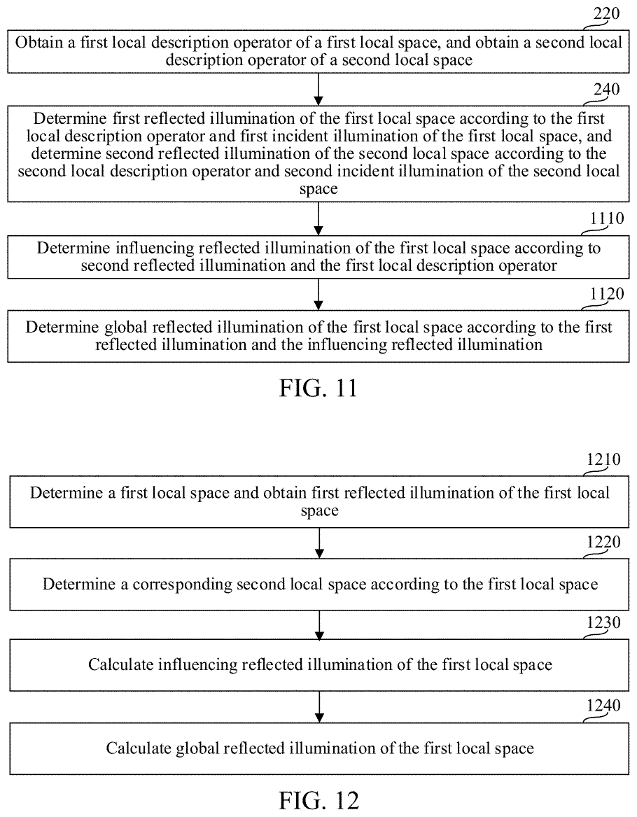

FIG. 11 is a flowchart of a method for calculating global illumination of a three-dimensional space provided by an example of the present subject matter. The method may be executed by a computer device. In an optional design, in the example in FIG. 2, step 260 includes:

Step 1110: Determine influencing reflected illumination of a first local space according to second reflected illumination and a first local description operator.

The influencing reflected illumination describes an influence of second reflected illumination of a second local space on a first local space; as an example, according to second reflected illumination and a first local description operator, a condition that the second reflected illumination is incident to a first local space is described, and a reflection condition of an object in the first local space to the second reflected illumination is determined.

In an optional implementation, influencing reflected illumination of a first local space is determined according to second reflected illumination, a first local description operator, and first visibility information;
where, the first visibility information describes whether an occlusion exists in a different illumination direction in a first local space; as an example, first visibility information is expressed as a binary function; as an example, in a case that no occlusion exists in a first direction in a local space, a function value corresponding to first visibility information in the first direction is 1; otherwise, in a case that an occlusion exists in a second direction in a local space, a function value corresponding to first visibility information in the second direction is 0;
further, sphere harmonics of influencing reflected illumination of a first local space is determined according to a product of sphere harmonics of second reflected illumination, a first local description operator, and first visibility information;
as an example, influencing reflected illumination is determined as:

$${SHL}_{e} = \frac{{\sum }_{i = 1}^{n} Basis ( {β}_{i} ) \cdot {SHL}_{i} \cdot Basis ( - {β}_{i} ) 4 π}{n}$$

inf LocalRef·the first visibility information;

Lₑ where represents influencing reflected illumination, SH represents sphere harmonics, βᵢ represents a direction vector in a corresponding second reflected light Lᵢ direction, Lᵢ represents second reflected illumination, Basis represents an orthogonal basis operation, LocalRef represents a first local description operator, inf represents lower bound operation and n represents an amount of second reflected illumination.

Step 1120: Determine global reflected illumination of the first local space according to the first reflected illumination and the influencing reflected illumination.

As an example, first reflected illumination describes a reflection condition of an object in a first local space to first incident illumination, and influencing reflected illumination describes a reflection condition of an object in the first local space to second reflected illumination; second reflected illumination of a second local space influences the first local space, that is, the second reflected illumination irradiates the first local space.

In an optional implementation, first reflected illumination is added to influencing reflected illumination to obtain global reflected illumination of a first local space; a person skilled in the art may understand that global reflected illumination of a first local space obtained by addition is only an exemplary adding method, and the global reflected illumination of the first local space may be determined by at least one of weighted addition, vector superposition, or another manner.

In this example, the influencing reflected illumination of the first local space is determined by second reflected illumination and a first local description operator; similarly, for the second local space, influencing reflected illumination of the second local space may be determined in a manner similar to the above steps; a person skilled in the art may understand that influencing reflected illumination of a second local space is similar to second reflected illumination and also influences an illumination condition of the first local space, and according to the implementation shown in step 1110, secondary influencing reflected illumination of the first local space may be determined according to the influencing reflected illumination of the second local space and a first local description operator. It may be understood that a calculation process may be iterated for multiple times, and secondary influencing reflected illumination to multiple reflected illumination of the first local space may be calculated in turn; as an example, in a case of calculating multiple reflected illumination, global reflected illumination of a first local space is a sum of first reflected illumination, influencing reflected illumination of the first local space, and secondary influencing reflected illumination to multiple influencing reflected illumination of the first local space.

To sum up, according to the method provided by the example, the global reflected illumination of the first local space is determined by the first local description operator, the first reflected illumination and the second reflected illumination, complexity of calculating global illumination is simplified, a problem of a large calculation amount caused by the fact that reflected illumination of all positions in a three-dimensional space needs to be used when global reflected illumination of one position is calculated is avoided, and a calculation dimension of calculating the global reflected illumination by the reflected illumination of the second local space is expanded; a calculation amount of global illumination calculation is effectively reduced.

FIG. 12 is a flowchart of a method for determining global reflected illumination of a local space provided by an example of the present subject matter. The method may be executed by a computer device. The method includes:

Step 1210: Determine a first local space and obtain first reflected illumination of the first local space.

As an example, according to a first local description operator, first incident illumination and first visibility information, a condition that the first incident illumination is incident to a first local space is described, and a reflection condition of an object in the first local space to the first incident illumination is determined.

A representation form of incident illumination or reflected illumination of a first local space includes but is not limited to a matrix, a vector, and a function; the first visibility information describes whether an occlusion exists in a different illumination direction in a first local space;

Step 1220: Determine a corresponding second local space according to the first local space.

The second local space is determined by a spacing distance with the first local space;

Step 1230: Calculate influencing reflected illumination of the first local space.

The influencing reflected illumination describes an influence of second reflected illumination of a second local space on a first local space; as an example, according to second reflected illumination and a first local description operator, a condition that the second reflected illumination is incident to a first local space is described, and a reflection condition of an object in the first local space to the second reflected illumination is determined.

Step 1240: Calculate global reflected illumination of the first local space.

First reflected illumination and influencing reflected illumination are added to obtain global reflected illumination of the first local space.

To sum up, according to the method provided by the example, the global reflected illumination of the first local space is determined by the first local description operator, the first reflected illumination and the second reflected illumination, complexity of calculating global illumination is simplified, a problem of a large calculation amount caused by the fact that reflected illumination of all positions in a three-dimensional space needs to be used when global reflected illumination of one position is calculated is avoided, and a calculation dimension of calculating the global reflected illumination by the reflected illumination of the second local space is expanded; a calculation amount of global illumination calculation is effectively reduced.

Next, a process of determining global reflected illumination of a three-dimensional space is introduced:

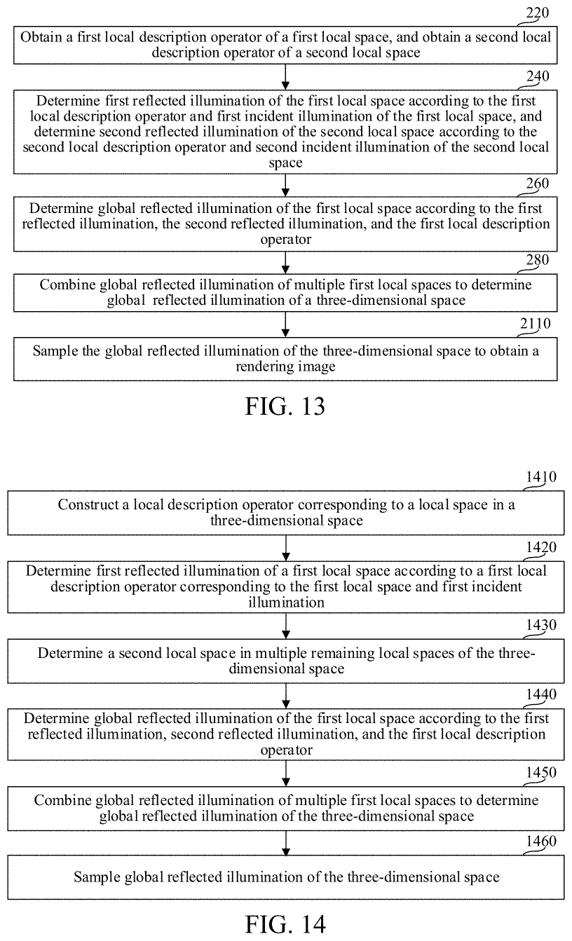

FIG. 13 is a flowchart of a method for calculating global illumination of a three-dimensional space provided by an example of the present subject matter. The method may be executed by a computer device. In an optional design, based on the example in FIG. 2, the following steps are further included:

Step 280: Combine global reflected illumination of multiple first local spaces to determine global reflected illumination of a three-dimensional space.

As an example, a three-dimensional space includes multiple first local spaces, and global reflected illumination of the multiple first local spaces is combined according to positions of the first local spaces in the three-dimensional space to obtain global reflected illumination of the three-dimensional space; as an example, global reflected illumination of a three-dimensional space describes a reflection condition of all objects in the three-dimensional space to all illumination incident to a first local space;
as an example, in this example, global reflected illumination is determined for all local spaces in the three-dimensional space, that is, all the local spaces in the three-dimensional space are determined as multiple first local spaces simultaneously or one by one, and corresponding global reflected illumination is determined.

Step 2110: Sample the global reflected illumination of the three-dimensional space to obtain a rendering image.

The rendering image is an image by observing a three-dimensional space with global reflected illumination calculated at a first view angle; the global reflected illumination of the three-dimensional space describes a reflection condition of light incident to the three-dimensional space in the three-dimensional space; that is, the three-dimensional space with the global reflected information may be obtained according to the global reflected illumination of the three-dimensional space; the three-dimensional space is observed at a first view angle, and by sampling, a corresponding rendering image is obtained.

A process of sampling global reflected illumination in the three-dimensional space is performed at an angle corresponding to the first view angle, that is, an image of the global reflected illumination of the three-dimensional space on a two-dimensional image is sampled at the angle corresponding to the first view angle.

To sum up, according to the method provided by the example, global reflected illumination of the first local space is determined by a first local description operator, first reflected illumination and second reflected illumination, complexity of calculating global illumination is simplified, and a calculation dimension of calculating the global reflected illumination by reflected illumination of a second local space is expanded; a calculation amount of global illumination calculation is effectively reduced, and a dimension of obtaining a rendering picture of a three-dimensional space is expanded.

FIG. 14 is a flowchart of a method for calculating global illumination of a three-dimensional space provided by an example of the present subject matter. The method may be executed by a computer device. The method includes:

Step 1410: Construct a local description operator corresponding to a local space in a three-dimensional space.

As an example, a three-dimensional space includes at least two local spaces; further, for constructing a local description operator corresponding to a local space, all or a part of local spaces in the three-dimensional space may be used; in this example, a process of constructing a local description operator may be completed by one step at a time or multiple steps at multiple times; as an example, in a case of separately completing a local description operator for a local space, a first local description operator for a first local space is completed before step 720, and a local description operator for a second local space is completed before step 740.

Step 1420: Determine first reflected illumination of a first local space according to a first local description operator corresponding to the first local space and first incident illumination;
as an example, first reflected illumination of a first local space describes a reflection condition after first incident illumination is incident to the first local space.

As an example, first reflected illumination may be expressed as:

SHLₒ=SHLᵢ·LocalRef;

Lₒ where represents first reflected illumination, Lᵢ represents first incident illumination, SH represents sphere harmonics, and LocalRef represents a first local description operator.

Step 1430: Determine a second local space in multiple remaining local spaces of the three-dimensional space.

As an example, in an optional implementation of this example, a second local space may be determined by a spacing distance with a first local space;

Step 1440: Determine global reflected illumination of the first local space according to the first reflected illumination, second reflected illumination, and the first local description operator.

As an example, global reflected illumination of a first local space describes reflection conditions of all objects in the first local space to all illumination incident to the first local space in a three-dimensional space;

Step 1450: Combine global reflected illumination of multiple first local spaces to determine global reflected illumination of the three-dimensional space.

As an example, global reflected illumination of the multiple first local spaces is combined according to a position of each first local space in the three-dimensional space to obtain global reflected illumination of the three-dimensional space; as an example, global reflected illumination of a three-dimensional space describes a reflection condition of all objects in the three-dimensional space to all illumination incident to a first local space;

Step 1460: Sample global reflected illumination of the three-dimensional space.

A first image obtained by sampling the global reflected illumination of the three-dimensional space is an image obtained by observing the three-dimensional space at a first view angle; a process of sampling global reflected illumination in the three-dimensional space is performed at an angle corresponding to the first view angle, that is, an image of the global reflected illumination of the three-dimensional space on a two-dimensional image is sampled at the angle corresponding to the first view angle.

To sum up, according to the method provided by the example, by determining the first reflected illumination of the first local space, a process of calculating reflected illumination of illumination space points one by one is simplified and a connection is established between the reflected illumination of the first local space and the first local space; by the first local description operator, the first reflected illumination and the second reflected illumination, the global reflected illumination of the first local space is determined, complexity of calculating global illumination is simplified, a problem of a large calculation amount caused by the fact that reflected illumination of all positions in a three-dimensional space needs to be used when global reflected illumination of one position is calculated is avoided, and a calculation dimension of calculating the global reflected illumination by the reflected illumination of the second local space is expanded; a calculation amount of global illumination calculation is effectively reduced.

A person of ordinary skill in the art may understand that the above examples may be implemented independently, or the above examples may be freely combined to form a new example to implement a method for calculating global illumination in a three-dimensional space of the present subject matter.

Taking a three-dimensional space being a three-dimensional game space under a game scene as an example, the following will introduce a method for calculating global illumination in a three-dimensional game space.

A three-dimensional game space refers to a space accommodating a three-dimensional virtual environment in a game field, and the three-dimensional virtual environment is a virtual environment displayed (or provided) when a client runs on a terminal. The virtual environment may be a simulation environment of a real world, a semi-simulation and semi-fictional environment, or a purely fictional environment. Optionally, the three-dimensional virtual environment may provide a battle environment for a virtual object. As an example, in a battle royale type game, at least one virtual object plays a single game in a virtual environment, the virtual object achieves a purpose of surviving in the virtual environment by avoiding an attack launched by an enemy unit and a danger (such as a gas ring and a swamp) existing in the virtual environment, and in a case that the life value of the virtual object in the visual environment is zero, the virtual object's life in the virtual environment ends, and a last surviving virtual object is a winner.

In an optional example, a terminal obtains a first local description operator of a first local game space and obtains a second local description operator of a second local game space; first reflected illumination of the first local game space is determined according to the first local description operator and first incident illumination of the first local game space, and second reflected illumination of the second local game space is determined according to the second local description operator and second incident illumination of the second local game space; global reflected illumination of the first local game space is determined according to the first reflected illumination, the second reflected illumination, and the first local description operator; where the first local description operator describes space information of the first local game space, and the second local description operator describes space information of the second local game space.

In an optional example, a terminal determines influencing reflected illumination of a first local game space according to second reflected illumination and a first local description operator, the influencing reflected illumination describes an influence of second reflected illumination of a second local game space on the first local game space; global reflected illumination of the first local game space is determined according to the first reflected illumination and influencing reflected illumination.

In an optional example, a terminal determines influencing reflected illumination of a first local game space according to second reflected illumination, a first local description operator, and first visibility information, the first visibility information describes whether an occlusion exists in a different illumination direction in the first local game space.

In an optional example, a terminal determines sphere harmonics of influencing reflected illumination of a first local game space according to a product of sphere harmonics of second reflected illumination, a first local description operator, and first visibility information.

In an optional example, a terminal determines first reflected illumination according to a first local description operator, first incident illumination and first visibility information, the first visibility information describes whether an occlusion exists in a different illumination direction in the first local game space; second reflected illumination is determined according to a second local description operator, second incident illumination and second visibility information, the second visibility information describes whether an occlusion exists in a different illumination direction in a second local game space.

In an optional example, a terminal determines sphere harmonics of first reflected illumination according to a product of a first local description operator, sphere harmonics of first incident illumination, and first visibility information; second reflected illumination is determined according to a second local description operator, second incident illumination and second visibility information, including: determining sphere harmonics of second reflected illumination according to a second local description operator, sphere harmonics of second incident illumination and second visibility information.

In an optional example, a terminal obtains at least two local game spaces by dividing in a three-dimensional game space; a first local game space is determined in the at least two local game spaces; according to position information of the first local game space, a second local game space is determined in multiple remaining local game spaces, the remaining local game spaces is local game spaces other than the first local game space in the at least two local game spaces.

In an optional example, a terminal calculates spacing distances between a first local game space and multiple remaining local game spaces respectively according to position information of the first local game space; the multiple remaining local game spaces are sorted from small to large according to the spacing distances; first a remaining local game spaces in the sorting are determined as second local game spaces, a is a positive integer.

In an optional example, a terminal obtains at least two local spaces by dividing in a three-dimensional game space according to a distribution condition of objects in the three-dimensional game space.

In an optional example, a terminal determines a space with a first object as a first subspace according to a distribution condition of objects in a three-dimensional game space; at least two local game spaces are obtained by dividing in the first subspace according to at least one of a material and a structure of a first object and position information in the first subspace.

In an optional example, a terminal constructs a first local description operator of a first local game space according to a first object in the first local game space, and constructs a second local description operator of a second local game space according to a second object in the second local game space.

In an optional example, a terminal constructs a first local description operator of a first local game space according to at least one of a material and a structure of a first object and position information in the first local game space, and constructs a second local description operator of a second local game space according to at least one of a material and a structure of a second object and position information in the second local game space.

In an optional example, a terminal combines global reflected illumination of multiple first local game spaces to determine global reflected illumination of a three-dimensional game space; the global reflected illumination of the three-dimensional game space is sampled to obtain a rendering image, the rendering image is an image by observing a three-dimensional game space with global reflected illumination calculated at a first view angle.

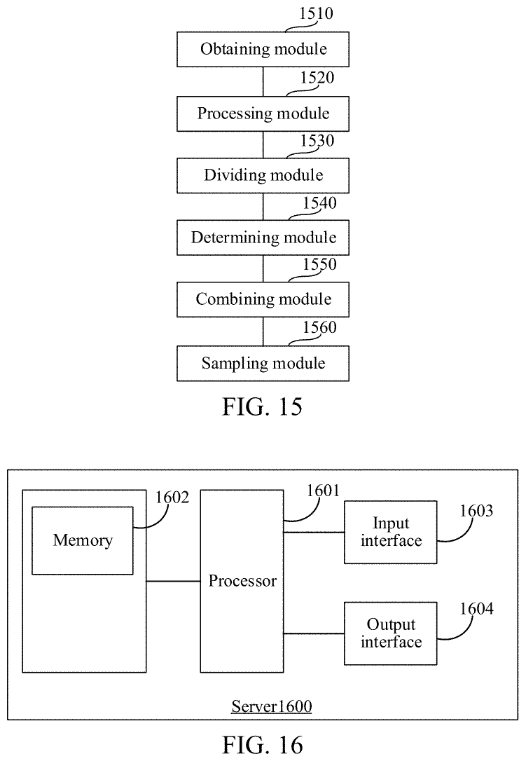

FIG. 15 is a block diagram of an apparatus for calculating global illumination in a three-dimensional space provided by an example of the present subject matter. The three-dimensional space includes a first local space and a second local space. The apparatus includes:
an obtaining module 1510, configured to obtain a first local description operator of the first local space and a second local description operator of the second local space;
a processing module 1520, configured to determine first reflected illumination of the first local space according to the first local description operator and first incident illumination of the first local space, and determine second reflected illumination of the second local space according to the second local description operator and second incident illumination of the second local space;
the processing module 1520, further configured to determine global reflected illumination of the first local space according to the first reflected illumination, the second reflected illumination, and the first local description operator;
where the first local description operator describes space information of the first local space, the second local description operator describes space information of the second local space, the second local space is an associated space of the first local space, and second reflected illumination of the second local space influences the first local space.

In an optional design of the example, the processing module 1520 is further configured to: determine influencing reflected illumination of the first local space according to the second reflected illumination and the first local description operator, the influencing reflected illumination describes an influence of second reflected illumination of the second local space on the first local space;
determine the global reflected illumination of the first local space according to the first reflected illumination and the influencing reflected illumination.

In an optional design of the example, the processing module 1520 is further configured to: determine the influencing reflected illumination of the first local space according to the second reflected illumination, the first local description operator, and first visibility information, the first visibility information describes whether an occlusion exists in a different illumination direction in the first local space.

In an optional design of the example, the processing module 1520 is further configured to:
determine sphere harmonics of the influencing reflected illumination of the first local space according to a product of sphere harmonics of the second reflected illumination, the first local description operator, and the first visibility information.

In an optional design of the example, the processing module 1520 is further configured to:
determine the first reflected illumination according to the first local description operator, the first incident illumination, and first visibility information, the first visibility information describes whether an occlusion exists in a different illumination direction in a first local space;
determine the second reflected illumination according to the second local description operator, the second incident illumination, and second visibility information, the second visibility information describes whether an occlusion exists in a different illumination direction in a second local space.

In an optional design of the example, the processing module 1520 is further configured to:
determine sphere harmonics of the first reflected illumination according to a product of the first local description operator, sphere harmonics of the first incident illumination, and the first visibility information;
determine sphere harmonics of the second reflected illumination according to a product of the second local description operator, sphere harmonics of the second incident illumination, and the second visibility information.

In an optional design of the example, the apparatus may further include:
a dividing module 1530, configured to divide to obtain at least two local spaces in the three-dimensional space;
a determining module 1540, configured to determine a first local space from the at least two local spaces;
the determining module 1540, further configured to determine the second local space from multiple remaining local spaces according to position information of the first local space, the remaining local spaces is local spaces other than the first local space in the at least two local spaces.

In an optional design of the example, the determining module 1540 is further configured to:
calculate spacing distances between the first local space and the remaining local spaces according to position information of the first local space;
sort the multiple remaining local spaces from small to large according to the spacing distances;
determine first the remaining local spaces in the sorting as the second local spaces, a is a positive integer.

In an optional design of the example, the dividing module 1530 is further configured to: divide to obtain the at least two local spaces in the three-dimensional space according to a distribution condition of objects in the three-dimensional space.

In an optional design of the example, the dividing module 1530 is further configured to:
determine a space with a first object as a first subspace according to a distribution condition of objects in the three-dimensional space;
divide to obtain at least two local spaces in the first subspace according to at least one of a material and a structure of the first object and position information in the first subspace.

In an optional design of the example, the determining module 1540 is further configured to: construct the first local description operator of the first local space according to a first object in the first local space, and construct the second local description operator of the second local space according to a second object in the second local space.

In an optional design of the example, the determining module 1540 is further configured to:
construct the first local description operator of the first local space according to at least one of a material and a structure of the first object and position information of the first local space, and construct the second local description operator of the second local space according to at least one of a material and a structure of the second object and position information of the second local space.

In an optional design of the example, a three-dimensional space includes multiple first local spaces, and the apparatus further includes:
a combining module 1550, configured to combine the global reflected illumination of the multiple first local spaces to determine global reflected illumination of the three-dimensional space;
a sampling module 1560, configured to sample the global reflected illumination of the three-dimensional space to obtain a first image, the first image is an image obtained by observing the three-dimensional space at a first view angle.

In a case that the apparatus provided by the example implements functions of the apparatus, only division of the above function modules is used as an example for description. In practical application, the functions may be allocated to and completed by different function modules according to requirements. That is, a content structure of the device is divided into different function modules to complete all or some of the functions described above.

With regard to the apparatus in the above example, the specific manner in which each module performs an operation has been described in detail in the example of the method; technical effects achieved by an operation performed by each module are the same as those in the examples of the method, and will not be described in detail herein.

The term module (and other similar terms such as unit, subunit, submodule, etc.) in the present disclosure may refer to a software module, a hardware module, or a combination thereof. Modules implemented by software are stored in memory or non-transitory computer-readable medium. The software modules, which include computer instructions or computer code, stored in the memory or medium can run on a processor or circuitry (e.g., ASIC, PLA, DSP, FPGA, or other integrated circuit) capable of executing computer instructions or computer code. A hardware module may be implemented using one or more processors or circuitry. A processor or circuitry can be used to implement one or more hardware modules. Each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices and stored in memory or non-transitory computer readable medium.

An example of the present subject matter further provides a computer device. The computer device includes: a processor and a memory, the memory storing a computer program. The processor is configured to execute the computer program in the memory to realize a method for calculating global illumination of a three-dimensional space provided by each method example.

Optionally, a computer device may be a terminal or a server. As an example, FIG. 16 is a schematic structural diagram of a server provided by an example of the present subject matter.

Generally, a server 1600 includes: a processor 1601 and a memory 1602.

The processor 1601 may include one or more processing cores, for example, a 4-core processor or an 8-core processor. The processor 1601 may be implemented in at least one hardware form of a digital signal processing (DSP), a field-programmable gate array (FPGA), and a programmable logic array (PLA). The processor 1601 may also include a main processor and a coprocessor. The main processor is a processor configured to process data in an awake state, and is also referred to as a central processing unit (CPU); The coprocessor is a low-power consumption processor for processing data in a standby state. In some examples, a processor 1601 may be integrated with a graphics processing unit (GPU). The GPU is configured to render and draw a content that needs to be displayed on a display screen. In some examples, a processor 1601 may further include an artificial intelligence (AI) processor. The AI processor is configured to process computing operations related to machine learning.

The memory 1602 may include one or more computer-readable storage media. The computer-readable storage medium may be non-transient. The memory 1602 may further include a high-speed random access memory and a nonvolatile memory, for example, one or more disk storage devices or flash storage devices. In some examples, a non-transitory computer-readable storage medium in a memory 1602 is configured to store at least one instruction, the at least one instruction is configured to be executed by a processor 1601 to implement a method for calculating global illumination of a three-dimensional space provided by a method example in the present subject matter.

In some examples, a server 1600 optionally further includes: an input interface 1603 and an output interface 1604. A processor 1601, a memory 1602, an input interface 1603 and an output interface 1604 may be connected through a bus or a signal cable. Each peripheral device may be connected to the input interface 1603 and the output interface 1604 through a bus, a signal cable, or a circuit board. The input interface 1603 and the output interface 1604 may be used for connecting at least one peripheral device related to Input/Output (I/O) to the processor 1601 and the memory 1602. In some examples, a processor 1601, a memory 1602, an input interface 1603 and an output interface 1604 are integrated on the same chip or circuit board; in some other examples, any one or two of a processor 1601, a memory 1602, an input interface 1603 and an output interface 1604 may be implemented on a single chip or circuit board. This is not limited in this example.

A person skilled in the art may understand that the structure shown above constitutes no limitation on a server 1600, and the server may include more or fewer components than those shown in the figure, or some components may be combined, or a different component deployment may be used.

In an example, a chip is further provided. The chip includes a programmable logic circuit and/or a program instruction and is used for realizing the above method for calculating global illumination of a three-dimensional space in a case that the chip runs on a computer device.

In an example, a computer program product is further provided. The computer program product includes a computer instruction stored in a non-transitory computer-readable storage medium. A processor of a computer device reads a computer instruction from a non-transitory computer-readable storage medium. The processor reads and executes the computer instruction from the computer-readable storage medium, so as to implement a method for calculating global illumination of a three-dimensional space provided by each above method example.

In an example, a non-transitory computer-readable storage medium is further provided. The computer-readable storage medium stores a computer program, and the computer program is loaded and executed by a processor to implement a method for calculating global illumination of a three-dimensional space provided by each above method example.

A person of ordinary skill in the art may understand that all or some of the steps of the above examples may be implemented by hardware, or may be implemented by a program instructing relevant hardware. The program may be stored in a non-transitory computer-readable storage medium. The above mentioned storage medium may be a read-only memory, a magnetic disk, an optical disc, or the like.

What is claimed is:

1. A method executed by a terminal for calculating global illumination of a three-dimensional space, wherein the three-dimensional space comprises a first local space and a second local space, comprising:
obtaining a first local description operator of the first local space;
obtaining a second local description operator of the second local space;
determining a first reflected illumination of the first local space according to the first local description operator and a first incident illumination of the first local space;
determining a second reflected illumination of the second local space according to the second local description operator and a second incident illumination of the second local space; and
determining a global reflected illumination of the first local space according to the first reflected illumination, the second reflected illumination, and the first local description operator, wherein
the first local description operator describes space information of the first local space, and
the second local description operator describes space information of the second local space.

2. The method according to claim 1, wherein the global reflected illumination of the first local space is determined according to the first reflected illumination, the second reflected illumination, and the first local description operator, the method further comprising:
determining influencing reflected illumination of the first local space according to the second reflected illumination and the first local description operator, wherein
the influencing reflected illumination describes an influence of second reflected illumination of the second local space on the first local space; and
determining the global reflected illumination of the first local space according to the first reflected illumination and the influencing reflected illumination.

3. The method according to claim 2, wherein the influencing reflected illumination of the first local space is determined according to the second reflected illumination and the first local description operator, the method further comprising:
determining the influencing reflected illumination of the first local space according to the second reflected illumination, the first local description operator, and first visibility information, wherein
the first visibility information describes whether an occlusion exists in a different illumination direction in the first local space.

4. The method according to claim 3, wherein the influencing reflected illumination of the first local space is determined according to the second reflected illumination, the first local description operator, and the first visibility information, the method further comprising:
determining sphere harmonics of the influencing reflected illumination of the first local space according to a product of sphere harmonics of the second reflected illumination, the first local description operator, and the first visibility information.

5. The method according to claim 3, wherein the first reflected illumination of the first local space is determined according to the first local description operator and the first incident illumination of the first local space, and the second reflected illumination of the second local space is determined according to the second local description operator and the second incident illumination of the second local space, the method further comprising:
determining the first reflected illumination according to the first local description operator, the first incident illumination, and the first visibility information, wherein
the first visibility information describes whether an occlusion exists in a different illumination direction in the first local space; and
determining the second reflected illumination according to the second local description operator, the second incident illumination, and second visibility information, wherein
the second visibility information describes whether an occlusion exists in a different illumination direction in a second local space.

6. The method according to claim 5, wherein the first reflected illumination is determined according to the first local description operator, the first incident illumination, and the first visibility information, the method further comprising:
determining sphere harmonics of the first reflected illumination according to a product of the first local description operator, sphere harmonics of the first incident illumination, and the first visibility information, wherein
the second reflected illumination is determined according to the second local description operator, the second incident illumination, and the second visibility information; and
determining sphere harmonics of the second reflected illumination according to a product of the second local description operator, sphere harmonics of the second incident illumination, and the second visibility information.

7. The method according to claim 1, further comprising:
dividing to obtain at least two local spaces in the three-dimensional space;
determining the first local space from the at least two local spaces; and
determining the second local space from multiple remaining local spaces according to position information of the first local space, wherein
the remaining local spaces are local spaces other than the first local space in the at least two local spaces.

8. The method according to claim 7, wherein the second local space is determined from multiple remaining local spaces according to position information of the first local space, the method further comprising:
calculating separation distances between the first local space and the multiple remaining local spaces respectively according to position information of the first local space;
sorting the multiple remaining local spaces from small to large according to the separation distances; and
determining first a remaining local spaces in the sorting as second local spaces, wherein a is a positive integer.

9. The method according to claim 7, wherein at least two local spaces are obtained by dividing in the three-dimensional space, the method further comprising:
dividing to obtain the at least two local spaces in the three-dimensional space according to a distribution condition of objects in the three-dimensional space.

10. The method according to claim 9, wherein the at least two local spaces are obtained by dividing in the three-dimensional space according to a distribution condition of objects in the three-dimensional space, the method further comprising:
determining a space with a first object as a first subspace according to the distribution condition of objects in the three-dimensional space; and
dividing to obtain the at least two local spaces in the first subspace according to at least one of a material and a structure of the first object and position information in the first subspace.

11. The method according to claim 1, further comprising:
constructing the first local description operator of the first local space according to a first object in the first local space; and
constructing the second local description operator of the second local space according to a second object in the second local space.

12. The method according to claim 11, wherein the first local description operator of the first local space is constructed according to the first object in the first local space, and the second local description operator of the second local space is constructed according to the second object in the second local space, the method further comprising:
constructing the first local description operator of the first local space according to at least one of a material and a structure of the first object and position information in the first local space; and
constructing the second local description operator of the second local space according to at least one of a material and a structure of the second object and position information in the second local space.

13. The method according to claim 1, wherein the three-dimensional space comprises multiple first local spaces, the method further comprising:
combining the global reflected illumination of the multiple first local spaces to determine global reflected illumination of the three-dimensional space; and
sampling the global reflected illumination of the three-dimensional space to obtain a rendering image, wherein
the rendering image is an image by observing the three-dimensional space with the global reflected illumination calculated at a first view angle.

14. An apparatus for calculating global illumination of a three-dimensional space, wherein the three-dimensional space comprises a first local space and a second local space, the apparatus comprising:
an obtaining module configured to obtain a first local description operator of the first local space and a second local description operator of the second local space; and
a processing module configured to:
determine first reflected illumination of the first local space according to the first local description operator and first incident illumination of the first local space,
determine second reflected illumination of the second local space according to the second local description operator and second incident illumination of the second local space, and
determine global reflected illumination of the first local space according to the first reflected illumination, the second reflected illumination, and the first local description operator, wherein
the first local description operator describes space information of the first local space, and
the second local description operator describes space information of the second local space.

15. The apparatus according to claim 14, wherein the processing module is further configured to:
determine influencing reflected illumination of the first local space according to the second reflected illumination and the first local description operator, wherein
the influencing reflected illumination describes an influence of second reflected illumination of the second local space on the first local space; and
determine the global reflected illumination of the first local space according to the first reflected illumination and the influencing reflected illumination.

16. The apparatus according to claim 15, wherein the processing module is further configured to:
determine the influencing reflected illumination of the first local space according to the second reflected illumination, the first local description operator, and first visibility information, wherein
the first visibility information describes whether an occlusion exists in a different illumination direction in the first local space.

17. The apparatus according to claim 16, wherein the processing module is further configured to:
determine harmonics of the influencing reflected illumination of the first local space according to a product of sphere harmonics of the second reflected illumination, the first local description operator, and the first visibility information.

18. A computer device, comprising:
a processor; and
a memory in communication with the processor and storing instructions executable by the processor to configure the computer device to perform the method for calculating global illumination of a three-dimensional space according to claim 1.
